(19) United States
(12) Patent Application Publication
(10) Pub. No.: US 2006/0136970 A1
(43) Pub. Date: Jun. 22, 2006

(54) Joint bit rate control

(76) Inventor: Eduard W. Salomons, Dublin (IE)

Correspondence Address: Philips Electronics North America Corporation;Corporate Patent Counsel, P O Box 3001, Briarcliff Manor, NY, 10510, US

(21) Appl. No.: 10/541,416

(22) PCT Filed: Dec. 19, 2003
(86) PCT No.: PCT/IB03/06165

§ 371 Date: Nov. 21, 2005

(30) Foreign Application Priority Data
Jan. 7, 2003 (GB) 0300359.7

(51) Int. Cl. H04N 7/18

(52) U.S. Cl. 725/81

(57) ABSTRACT

A gateway 15 of an in-home audio visual distribution system comprises first to third encoder or transcoders 20-22, each being associated with a respective buffer 23-25. Each encoder or transcoder and buffer combination process signals from a different input channel. Data signals from the buffers are scheduled by an earliest deadline first scheduler 26 for transmission over a wireless link via a transmitter 17. A joint bit rate controller 27 is arranged to control the encoders or transcoders to adopt a bit rate which is dependent on the amount of data stored in the buffers 23-25 awaiting transmission, particularly on the difference between the amount of data and a target amount. The output bit rate of the encoders or transcoders is dependent also on the complexity of the content being coded. Following a channel change or start-up event, the scheduler 26 is controlled to transmit data for the relevant channel with priority over data for the other channels.

The present invention relates to an audio-visual content transmission system, and to a method for use in the control of such.

Various proposals exist for home audiovisual (AV) content distribution systems. It is appreciated that there are installation and cost benefits to be achieved by systems which have a central gateway connected to displays distributed around a home by wireless links. However, the provision of the wireless links poses a number of technical problems, some of which the present invention seeks to address.

Background information on joint bit-rate control can be found from “Multi-program video data compression”, by G. J.Keesman, of Eindhoven, Philips Research Laboratories,Thesis Technische Universiteit Delft—ISBN 90-74445-20-9

According to a first aspect of the present invention, there is provided apparatus for distributing audio-visual content over at least two channels, the total channel rate being unpredictable, the apparatus comprising a coder and a data buffer for each channel, and a transmission controller arranged to control the transmission of data from the buffers and to provide for the retransmission of data which is deemed not to have been received correctly, the apparatus comprising a joint bit-rate controller arranged to control each of the coders to provide data at a rate which is dependent at least in part on a data production rate and on a data transmission rate.

Each coder may be an encoder or a transcoder, depending on the nature of signals which it is designed to process. The preferred function of the data production and transmission rates is one which operates as a function of the amount of data awaiting transmission. The amount of data awaiting transmission may be measured directly, or inferred from other measured parameters, such as the data transmission rate and the data production rate.

This can provide a flexible system which modifies its operating parameters automatically depending on the operating environment. It also provides an efficient use of a buffering delay which, in the embodiments, adjusts the quality of coding to suit the buffer condition. This enables the substantially equal picture quality to be achieved by the signals on each channel, and is susceptible to the support of further channels.

Good reliability can be obtained by controlling the coders to provide ata at a rate which is dependent in part on the difference between the amount of data awaiting transmission and a target amount, preferably multiplied by a control parameter.

The joint bit-rate controller preferably is arranged to apply a control signal to a control input of each coder which determines directly the quality of encoding used, although it may instead be arranged to apply a control signal to a control input of each coder which determines directly the output data rate of the coder.

Good results are obtained if the transmission controller is an earliest deadline first scheduler.

According to a second aspect of the invention, there is provided a method of distributing audio visual content over at least two channels, the total channel rate being unpredictable, the method comprising providing a coder and a data buffer for each channel, controlling the transmission of data from the buffers and controlling the retransmission of data which is deemed not to have been received correctly, the method comprising controlling each of the coders to provide data at a rate which is dependent at least in part on a data production rate and on a data transmission rate.

Embodiments of the present invention will now be described, by way of example only, with reference to the accompanying drawings, of which:

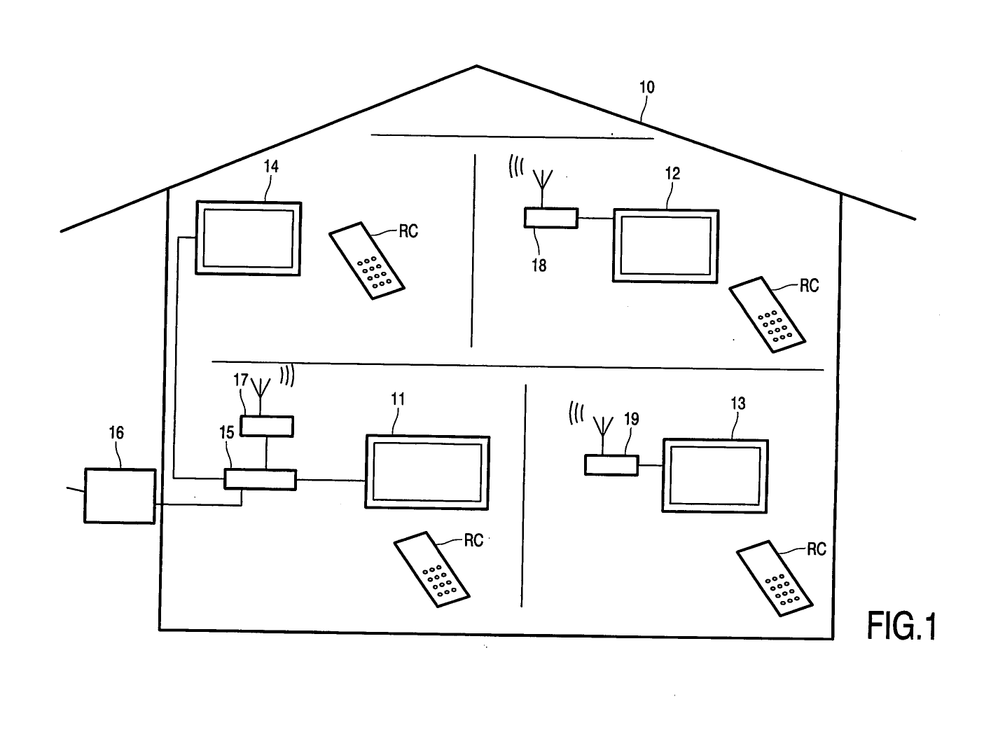

FIG. 1 is a schematic diagram of a home AV content distribution system to which the invention is applied;

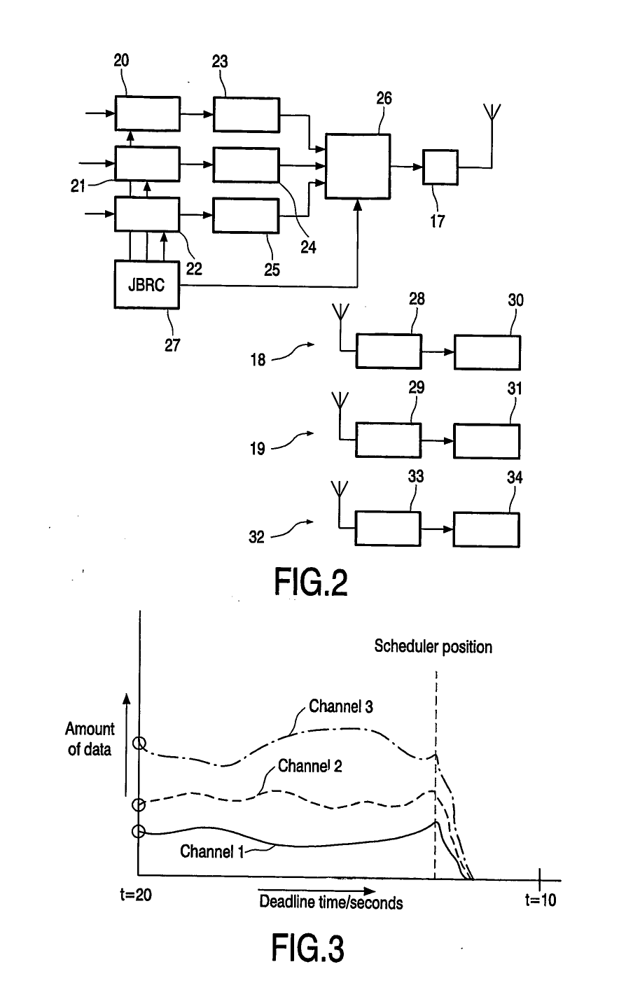

FIG. 2 shows an embodiment of certain components of the FIG. 1 system;

FIG. 3 illustrates buffer fullness at an encoder station of FIG. 2 in a steady state condition; and

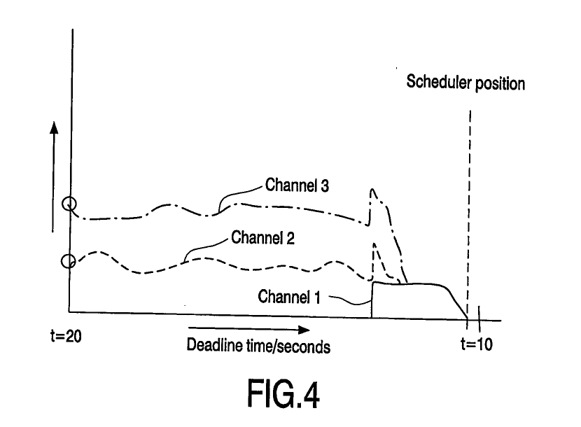

FIG. 4 illustrates buffer fullness at the encoder station soon after a channel-change condition.

Referring to FIG. 1, a house 10 is provided with first to fourth television sets 11 to 14, each set having a respective remote control RC. A gateway 15, in the form of a set-top box (STB) is connected to a video source 16, which may be a satellite dish, a conventional aerial, a cable TV source or an internet TV source to cite some non-limiting examples. The gateway 15 in this example has four output channels, two of which are wired to the first and the fourth TV sets by respective co-axial cables, and two of which are fed through a radio transceiver 17. The second and third TV sets 12, 13 have associated therewith respective radio transceivers 18, 19, each of which is operable to communicate with the gateway 15 via the transceiver 17. The radio transceivers 18, 19 can be referred to as ‘thin clients’, since they do not contain much processing resources or other hardware. Instead, a hard disk drive, broadband modem, a powerful processor and substantial quantities of solid state memory are provided in the gateway, which runs all processor intensive applications. Further fixed or portable radio transceivers (not shown) may be arranged to receive further output channels of the gateway 15. The gateway 15 may be constituted as a server, instead of an STB.

This example relates to the case where the video source has analogue output signals, rather than digitally encoded signals.

Components of the wireless channels are shown in FIG. 2. The gateway 15 comprises three channels, each including a respective encoder 20, 21, 22 and a buffer 23, 24, 25 connected in series. Audio and video signals for a channel are encoded separately, in the relevant encoder 20-22, [symbol] the encoded signals then multiplexed together. This may be achieved by separate audio and video encoders (not shown) in each channel. The encoding process results in the digital compression of the audio-visual signals.

Outputs of the buffers 23-25 are connected to respective inputs of a scheduler 26, an output of which is connected to the transceiver 17. The encoders 20-22 are controlled by a joint bit-rate controller (JBRC) 27. The encoders 20-22 each code analogue input signals into MPEG-2. Each encoder 20-22 includes a quantisation step size control input. A signal applied to the input by the JBRC determines the quantisation step size, and thus the quality of encoding in the output signals. For this reason, it is termed the Q input. The output bit rate is dependent on the complexity of the content and on the Q control input. Alternatively, quality control could be effected through the use of a different control input.

The scheduler 26 operates according to a modified EDF (earliest deadline first) algorithm, which prioritises the transmission of data which is due 15 for presentation earlier than other data. The transceivers 18, 19 each includes in series a respective buffer 28, 29 and a respective decoder 30, 31. A further transceiver 32 similarly includes a buffer 33 and a decoder in series.

The radio transceiver 17 is operable to send radio data frames in packets at a single frequency, for example using 802.11a. Each data frame is directed to a certain one of the receivers 18, 19. 32. The receivers 18, 19, 32 discard data frames which are not addressed to them. In general, the data frames each have the same duration. However, the number of data bits included in a data frame depends on the characteristics of the transmission path between the transmitter 17 and the relevant receiver 18, 19, 32. Where a transmission path has less favourable characteristics, fewer data bits are included in data frames transmitted over it, and vice versa. Accordingly, there may be different maximum transmission rates for the different receivers 18, 19, 32. A receiver 18, 19, 32 that is more distant from the transmitter 17 is able to receive less bits per time instance, since more bits in frames sent to it are used for error correction.

The notification of data frames which have been received properly at the receivers 18, 19, 32 is made by way of a low bandwidth channel from the relevant receiver to the transceiver 17. Retransmission of data frames which are not properly received occurs in any suitable manner. This low bandwidth channel may also carry remote control signals, for processing at the gateway 15, although these signals may instead be communicated separately. The channel might be a wireless channel, or may utilise pre-existing electrical supply cabling for instance.

The maximum amount of buffering in the system is limited by the amount of memory and by a desire to limit the perceived loss of quality when playing back at a lower speed. This embodiment utilises a 10 second buffering delay. The buffering delay for a channel is split between the buffer in the gateway 15 and the corresponding buffer in the receiver 18, 19, 32.

FIG. 3 shows the transmit buffer status for video data generated by the encoders for three separate analogue video sources (e.g. television channels), and are labelled channels 1, 2 and 3 respectively. The Figure illustrates the buffer status at time t=10. The time at which the data is intended to be decoded is termed the deadline time. On the horizontal axis, the deadline time for the data represented by the curves is shown from t=20 to t=10, which corresponds to the data that is currently displayed on the TVs. The data relating to deadline time t=20 is newly decoded by the decoders 20- 22. The amount of data present in the buffers 23-25 for a particular time is shown in a cumulative way, i.e. the value given for a point on the channel 3 line gives the total amount of data with a corresponding deadline time.

The dynamic behaviour of the system can be appreciated by visualising the curves in the Figure (including the markers on the horizontal axis) gradually moving towards the right. Data is produced by the encoders 20-22 at the circled positions. Data is consumed by the scheduler 26 at a position marked by the dotted vertical line. At any given time, the scheduler 26 selects for sending the data, from the front of one of the buffers 23-25, which has the earliest deadline. Each of the channels is treated equally. Some data resides to the right of the scheduler position in the buffer until acknowledged by the appropriate receiver 18, 19, 32, with or without retransmission.

The system shown in FIG. 3 is in a steady state since, at a given point in time, all three encoders 20-22 produce data with equal deadline times (i.e. t=20). Here, the total end-to-end delay has reached the maximum delay for all three channels. This delay equals 10 seconds (the difference in time between t=10 and t=20. The amount of data generated for the channels for a given deadline time is controlled by the JBRC 27. This determines the height of the curves in the future.

In such steady state conditions, the JBRC 27 operates in a LOOSE mode. Here, the same control signal is applied to the Q input of each of the 10 encoders 20-22, which results in equal quality encoding on each channel. In LOOSE mode, the JBRC 27 effects control of the encoders 20-22 with the aim of achieving 20% of the buffer delay for each channel in the gateway 15, with the other 80% being held at the receiver 18, 19, 32. This buffering condition provides a good tolerance to channel degradation. Where the buffer delay totals ten seconds, the aim is to store two seconds (equating to 20% of the total) of data in the gateway 15. This is achieved by updating the Q control input once every second according to equation (1):
Qnew=Qold−A(Dbuff−Dtarget) equation (1)
where Qnew is the next Q value, Qold is the existing value, Dbuff is the total amount of data in the gateway buffers 23-25 (in seconds) and Dtarget is the target buffer fullness (in seconds). A is a control parameter. Dtarget can be calculated as the target buffer fullness at the gateway multiplied by the number of active channels.

Since equation (1) calculates the difference between the actual buffer fullness and the target buffer fullness, buffer fullness can instead be measured in terms of bytes, frames or any other suitable measure. In this case, the target buffer fullness may need to be calculated using an estimate of the amount of data (or other measure) corresponding to the reproduction time target.

The value of A determines the reaction speed of the system to variations in buffer fullness. Variations can be caused by changes in the output channel rate (i.e. the throughput of data from the transmitter 17, taking into account retransmissions, and changes in the complexity of the content coded by the encoders 20-22. Since the control input affects the quality of encoding, and not the output bit rate, a higher complexity content on average would result in a higher average data rate. Due to equation (1), however, the system will naturally tend towards the target buffer fullness even as operating conditions charge our time. Also, since the same Q control signal is applied to each of the encoders 20-22, the perceived picture quality at each of the receivers 18, 19, 32 is optimised.

The above description of FIG. 3 relates to steady-state conditions, i.e. when all of the receivers 18, 19, 32 have been receiving data for their respective selected television channel for a relatively long period of time. The steady-state is upset when a user of the television 12, associated with the receiver 18, changes the source channel using the appropriate remote control RC. In response, the data buffers for the channel (i.e. at the gateway 15 and at the receiver 18) are emptied of data, and a different television channel is set up at the gateway . Immediately after the channel-change event, a minimal amount of buffering is set up in the system in order to allow the receiver 18 to start playback as soon as possible after the event. FIG. 4 shows an example of the state of the transmit buffers shortly after a channel change event for channel 1, again at a time t=10s. As with FIG. 3, the height of the line for channel 3 represents the total amount of data with a corresponding deadline in the transmit buffers 22, 23.

As can be seen, there is now data in the transmit buffer 22 for which the deadline is very close to the current time (t=10s). The scheduler 26 first sends out all the channel 1 data close to t=10 before considering any channel 2 or 3 data. This causes channel 1 to be allocated as much of the available channel bandwidth as required for a period of time, until the scheduler position moves such that the buffers for channel 2 or channel 3 contain data that has a deadline before the earliest deadline data for channel 1.

For channel 1, the encoder 20 inserts data with a deadline that is still quite near to the current time. However, reduced speed playback is used at the receiver 18, which causes the insertion point for channel 1 to move gradually towards the insertion points for the other channels. Reduced speed playback allows the build-up of a buffering delay (i.e. an increase in the amount of data in terms of the playback time) between encoders and decoders whilst audio-visual data is being consumed. Eventually, the steady state as shown in FIG. 3 is reached. A switch-on event is dealt with in substantially the same way, although of course it is not necessary to first empty the buffers. The fact that the buffer is distributed over the system also allows delay due to DSP constraints to occur without having a negative effect on content reproduction.

Following a channel-change event, normally, the LOOSE control is maintained, with the new channel being coded with the uniform quality Q. If this results in the production of data at a greater rate than the transmission rate, the gateway buffer will become more full and Q will gradually be controlled to a lower point by Equation (1). Because the new channel has the highest priority in the scheduler, a change to a channel that has complex content results in more gateway buffering for the other channels (which already have sufficient data available in the receive buffers anyway), whereas all the data for the new channel will be sent out straight away.

When a determination is made at the gateway 15 that the amount of data stored at the buffers in the receivers 18, 19, 32 is less than a threshold, for example 5 seconds per receiver, the JBRC 27 enters into a TIGHT mode. The determination may be made in any suitable way, for example by inferring the amount of data at the receivers 18, 19, 32 from the amount of data that is in the gateway buffers 23-25. This mode might be entered into if, for example, two or more channels are changed within a short time period.

When operating in TIGHT mode, the control signal applied to the Q inputs of the encoders 20-22 is calculated in a different way. In TIGHT mode, operation is more like that found in digital broadcasting. in which the output bit rate rather than the quality is the important parameter. The goal is control each encoder 20-22 to provide data at a specified bit rate, which may be different for each encoder. A target bit rate is set for each encoder, and the JBRC 27 seeks to achieve that bit rate as accurately as possible. An explanation follows, to aid understanding

The target bit rate depends on the complexity of the content. In a simple embodiment, it is assumed that all the receivers 18, 19, 32 are at the same distance from the transmitter 17, equal maximum transmission data rates would be obtained. In TIGHT mode, a goal of the JBRC 27 is to limit the total amount of data produced by the encoders 20-22 so that data is transmitted by the transmitter 17 at a greater rate than it is produced by the encoders.

This can be formalised as follows:
Rtotal=Rest−A(Dbuff) equation (2)
where A is a control parameter.

The rate of the channel at the time when the data that is currently being produced by the encoders 20-22 reaches the scheduler is not known because this time is in the future. Accordingly, a transmit channel rate Rest is estimated based on previous channel characteristics. This estimation may be made by calculating the average channel rate over the preceding ten minutes, and updating the estimation every minute. However, many other methods would be used instead. A total channel rate Rtotal is then calculated by subtracting from the estimated channel rate Rest a value that is proportional to the total amount of data in the transmit buffers Dbuff. Dbuff is the area below the channel 3 line bounded by the scheduler position in FIG. 3, and can be calculated in any convenient manner.

First of all the picture quality Qi, is assumed to be related to the channel rate Ri and the complexity of the content Xi as follows:
Qi=Ri/Xi Equation (3)
The manner in which the JBRC 27 operates to determine the complexity of the content of the channels is conventional. Since it is sought for the picture quality to be uniform over all channels:
Qi=Q Equation (4)
Q is a target quality, which is the same for all channels. Qi is the instantaneous quality control input for a channel. Since the actual complexity will differ from the estimated complexity, each of the Qi values is dynamically adjusted (and hence differs slightly from Q) by the JBRC 27 in order to achieve the target bit rate. The sum of the rates of the individual channels must equal the total rate:
Sum(Ri)=Rtotal. Equation (5)
Solving these equations yields the following for the channel rate Ri:
Ri=Rtotal×(Xi/sum(Xi)) equation (6)
And for the uniform target quality Q:
Q=Ri/Xi=Rtotal/Sum(Xi) Equation (7)
Depending on the type of encoder used, control may be effected by application of a suitable control signal to a quantisation step size input, or other quality control input, or a bit rate input of the encoder 20-22. Here, sum(Xi) is the sum of the complexities of the different channels.

Since the paths to the different receivers might be different, the amount of data transmittable in a data frame may differ accordingly. This is allowed for by a more sophisticated embodiment as follows. Here, since the total amount of time for transmitting the data is limited, the trade-off in allocation bandwidth between the individual channels changes. As an illustration, a data frame awarded to channel 1 for a near receiver might carry more data than if awarded to channel 2 for a more remote receiver. If the complexities of data for the channels 1 and 2 are equal, awarding the frame to channel 1 would yield the highest increase in picture quality. Accordingly, a separate estimation for the channel rate is made for each of the receivers 18, 19, 32. This results in estimated rates Rest,i which represent the channel rate that would be available to send data to a client if this client would have the channel for 100% of the time. Rest,i can be considered as a measure of the channel efficiency, i.e. the ratio of the number of data bits successfully converged to the number of data and error bits sent, including retransmitted data frames.

Equations (2) and (3) are assumed to hold. However equation (4) does not hold since the total rate now depends on the way the different channels share the medium (e.g. if a channel with a low rate has the channel for most of the time, Rtotal will be relatively low). To take this into account, a parameter Ni that denotes the part of the time a certain channel has access to the medium is introduced. If, for example, channel I holds 50% of the transmission channel, the Ni is 0.5.
Sum(Ni)=1 Equation (8)
Since the definition of Rest,i assumed that channel I held the channel for 100% of the time, the individual channel rate Ri is related to Ni and Rest,i as
Ri=Ni*Rest,i Equation (9)
Combining the above equations gives for Ri:
Ri=Xi/Sum(Xi/Rest,i) Equation (10)
From which the Q target can be calculated as:
Q=1/Sum(Xi/Rest,i) Equation (11)
Under normal conditions, the embodied system aims to provide a uniform picture quality both in time and over each of the receivers 18, 19, 32. However under critical conditions it may be decided to shut down completely the service on one or more of the receivers in order to still provide an acceptable performance on the remaining receivers. The scheduler 26 is arranged to monitor continually the transmission rates to the various receivers 18, 19, 32. The transmission rate calculation takes into account retransmissions. When it is detected that the transmission rate for a channel falls below a threshold, transmission of data frames on that channel is ceased. The relevant receiver 18, 19, 32 then causes an appropriate message to be displayed on its television. Data for the ceased channel stored in the relevant buffer at the gateway 15 is deleted as the deadline time for it passes. This feature prevents one badly positioned (as regards the path to it from the gateway 15) receiver from taking an unreasonable share of the channel bandwidth and thus negatively affecting the quality of the other channels. The quality of the link is subsequently monitored by the sending of test-packets. Transmission on that channel is resumed once the transmission rate is determined again to be satisfactory, for example by comparing the transmission rate to a threshold.

1. Apparatus (15) for distributing audio-visual content over at least two channels, the total channel rate being unpredictable, the apparatus comprising a coder (20-22) and a data buffer (23-25) for each channel, and a transmission controller (26) arranged to control the transmission of data from the buffers and to provide for the retransmission of data which is deemed not to have been received correctly, the apparatus comprising a joint bit-rate controller (27) arranged to control each of the coders to provide data at a rate which is dependent at least in part on a data production rate and on a data transmission rate.

2. Apparatus as claimed in claim 1, in which the coders are controlled to provide data at a rate which is dependent in part on the amount of data awaiting transmission.

3. Apparatus as claimed in claim 2, in which the coders are controlled to provide data at a rate which is dependent in part on the difference between the amount of data awaiting transmission and a target amount.

4. Apparatus as claimed in claim 3, in which the coders are controlled to provide data at a rate which is dependent on the difference multiplied by a control parameter.

5. Apparatus as claimed in claim 1, in which the joint bit rate controller is arranged to control each coder to provide data at a rate which is dependent in part on the complexity of the signal with which that coder is fed.

6. Apparatus as claimed in claim 1, in which the joint bit rate controller is arranged to control each coder to provide data at a rate which is dependent in part on an average data transmission rate and an average data production rate.

7. Apparatus as claimed in claim 5, in which the joint bit rate controller is arranged to control the coders to provide data at a rate which is dependent also on an estimated channel rate at a relevant time in the future.

8. Apparatus as claimed in claim 6, in which the estimated channel rate is calculated from historical channel rate data.

9. Apparatus as claimed in claim 1, in which the joint bit rate controller (27) is arranged to control a coder to provide data at a rate which is dependent in part on the characteristics of the channel associated with the coder.

10. Apparatus as claimed in claim 9, in which the joint bit rate controller (27) is arranged to control the coder to provide data at a rate which is dependent in part on the channel rate of the channel associated with the coder.

11. Apparatus as claimed in claim 10, in which the channel rate is calculated from the proportion of data bits transmitted to the total number of transmitted units.

12. Apparatus as claimed in claim 1, in which the joint bit-rate controller is arranged to apply a control signal to a control input of each coder which determines directly the quality of encoding used.

13. Apparatus as claimed in claim 1, in which the joint bit-rate controller is arranged to apply a control signal to a control input of each coder which determines directly the output data rate of the coder.

14. Apparatus as claimed in claim 1, in which the transmission controller is an earliest deadline first scheduler.

15. A method of distributing audio visual content over at least two channels, the total channel rate being unpredictable, the method comprising providing a coder (20-22) and a data buffer (23-25) for each channel, controlling the transmission of data from the buffers and controlling the retransmission of data which is deemed not to have been received correctly, the method comprising controlling each of the coders (20-22) to provide data at a rate which is dependent at least in part on a data production rate and on a data transmission rate.

16. A method as claimed in claim 15, in which the controlling step comprises controlling the coders to provide data at a rate which is dependent in part on the amount of data awaiting transmission.

17. A method as in claim 16, in which the controlling step comprises controlling the coders to provide data at a rate which is dependent in part on the difference between the amount of data awaiting transmission and a target amount.

18. A method as in claim 17, in which the controlling step comprises controlling the coders to provide data at a rate which is dependent on the difference multiplied by a control parameter.

19. A method as in claim 15, in which the controlling step comprises controlling the coders to provide data at a rate which is dependent in part on the complexity of the signal with which that coder is fed.

20. A method as in claim 15, in which the controlling step comprises controlling the coders to provide data at a rate which is dependent in part on an average data transmission rate and an average data production rate.

21. A method as in claim 15, in which the controlling step comprises controlling the coders to provide data at a rate which is dependent also on an estimated channel rate at a relevant time in the future.

22. A method as claimed in claim 15, comprising calculating the estimated channel rate from historical channel rate data.

23. A method as in claim 15, in which the controlling step comprises controlling the coders (20-22) to provide data at a rate which is dependent in part on the characteristics of the channel associated with the coder.

24. A method as claimed in claim 23, in which the controlling step comprises controlling the coders (20-22) to provide data at a rate which is dependent in part on the channel rate of the channel associated with the coder.

25. A method as claimed in claim 24, comprising calculating the channel rate from the proportion of data bits transmitted to the total number of transmitted units.
